(19) United States
(12) Patent Application Publication
(10) Pub. No.: US 2017/0203996 A1
(43) Pub. Date: Jul. 20, 2017

(54) MANUFACTURING METHOD FOR OPTICAL FIBER

(71) Applicant: FUJIKURA LTD., Tokyo (JP)

(72) Inventors: Takayuki Kitamura, Sakura-shi, Chiba (JP); Shunichirou Hirafune, Sakura-shi, Chiba (JP)

(73) Assignee: FUJIKURA LTD., Tokyo (JP)

(21) Appl. No.: 15/327,436

(22) PCT Filed: May 13, 2016
(86) PCT No.: PCT/JP2016/064232

§ 371 Date: Jan. 19, 2017

(30) Foreign Application Priority Data
Aug. 4, 2015 (JP) 2015-154531

(51) Int. Cl. C03B 37/025

(52) U.S. Cl. CPC C03B 37/0253; C03B 2205/56

(57) ABSTRACT

There is provided a manufacturing method for an optical fiber that easily reduces transmission losses in the optical fiber. The method includes a drawing process P1 of drawing an optical fiber from an optical fiber preform 1P in a drawing furnace 110; and a slow cooling process P3 of slowly cooling the optical fiber having been drawn in the drawing process P1 in an annealing furnace 121. The temperature of the optical fiber to be delivered into the annealing furnace 121 is a temperature of 1,300° C. or more and 1,650° C. or less. The temperature of the optical fiber to be delivered out of the annealing furnace 121 is a temperature of 1,150° C. or more and 1,400° C. less.

### TECHNICAL FIELD

The present invention relates to a manufacturing method for an optical fiber.

### BACKGROUND ART

In optical fiber communication systems, in order to increase optical transmission distances and optical transmission speed, the optical signal-to-noise ratio has to be increased. Thus, a decrease in transmission losses in optical fibers is demanded. Nowadays, a manufacturing method for an optical fiber is highly sophisticated. It is thought that transmission losses caused by impurities contained in optical fibers are decreased to nearly limits. A remaining main cause of transmission losses is scattering losses in association with variations in the structure or composition of glass forming optical fibers. This is inevitable, because optical fibers are formed of glass.

As a method of decreasing variations in the structure of glass, a method is known to cool molten glass slowly. As a method of slowly cooling glass, which is molten in this manner, an attempt is made to slowly cool an optical fiber immediately after the optical fiber is drawn from a drawing furnace. Specifically, it is investigated that an optical fiber drawn from a drawing furnace is heated in an annealing furnace, or an optical fiber immediately after being drawn is surrounded by a heat insulator to decrease the cooling rate of the optical fiber.

Patent Literature 1 below discloses a method of setting the temperature of a heating furnace (an annealing furnace), in which an optical fiber includes a core and a cladding whose principal component is silica glass, and the temperature of the furnace is ±100° C. or less of the target temperature found by a recurrence formula, in 70% or more of a region from a position at which the outer diameter of the optical fiber becomes smaller than 500% of the final outer diameter to a position at which the temperature of the optical fiber is 1,400° C. The temperature history of the optical fiber is controlled in this manner. Thus, the virtual temperature of glass forming the optical fiber is decreased to reduce transmission losses.

[Patent Literature 1] JP-A-2014-62021

### SUMMARY OF INVENTION

However, the technique disclosed in Patent Literature 1, above is required to repeat complex calculations in order to match the temperature of the optical fiber with an ideal temperature change found by a recurrence formula. The technique disclosed in Patent Literature 1 permits the temperature of the optical fiber to have a temperature shift of as large as ±50° C. to 100° C. with respect to the target temperature found by a recurrence formula. When the temperature shift of the optical fiber is permitted in such a wide range, it is difficult to say that the temperature history is sufficiently optimized. For example, supposing that the temperature of the optical fiber slowly cooled is changed in a range of ±100° C. and the virtual temperature of glass forming the optical fiber is also changed in a similar range, transmission losses of the obtained optical fiber caused by light scattering fluctuate as large as about ±0.007 dB/km. In such a previously existing manufacturing method in which the temperature history of the optical fiber is not sufficiently optimized, the annealing furnace has to be elongated more than necessary for excessive capital investment or the drawing rate has to be decreased more than necessary, resulting in degraded productivity.

The present inventors found that the temperature of the optical fiber to be delivered into the annealing furnace and the temperature of the optical fiber to be delivered out of the annealing furnace are limited to more suitable ranges, promoting the relaxation of the structure of glass forming the optical fiber in the annealing furnace to easily reduce transmission losses in the optical fiber.

Therefore, the present invention is to provide a manufacturing method for an optical fiber that easily reduces transmission losses in the optical fiber.

To solve the problem, a manufacturing method for an optical fiber according to the present invention includes: a drawing process of drawing an optical fiber preform in a drawing furnace; and a slow cooling process of slowly cooling the optical fiber drawn in the drawing process in an annealing furnace, wherein a temperature of the optical fiber to be delivered into the annealing furnace is a temperature of 1,300° C. or more and 1,650° C. or less, and a temperature of the optical fiber to foe delivered out of the annealing furnace is a temperature of 1,150° C. or more and 1,400° C. or less.

As described above, the temperature of the optical fiber to be delivered into the annealing furnace and the temperature of the optical fiber to be delivered out of the annealing furnace are appropriately controlled. Thus, the relaxation of the structure of glass forming the optical fiber can be promoted in the annealing furnace. Consequently, scattering losses caused by variations in the structure of glass in the transmission of light are reduced, and an optical fiber with decreased transmission losses can be obtained.

Preferably, in the slow cooling process, the temperature of the optical fiber is continuously decreased. The temperature of the annealing furnace is set so as to continuously decrease the temperature of the optical fiber in this manner. Thus, the optical fiber is slowly cooled to promote the relaxation of the structure of glass forming the optical fiber without wasting energy, allowing a reduction in transmission losses in the optical fiber.

Preferably, the method includes a rapid cooling process of rapidly cooling the optical fiber faster than in the slow cooling process after the slow cooling process. The optical fiber is typically covered with a buffer layer made of an ultraviolet curable resin. In order to form such a buffer layer, it is necessary to sufficiently cool the optical fiber. The rapid cooling process is included. Thus, the temperature of the optical fiber can be sufficiently decreased in a short section, allowing the buffer layer to be easily formed. Consequently, the buffer layer can be easily formed.

Preferably, the temperature of the optical fiber to be delivered into the annealing furnace is a temperature of 1,400° C. or more. The temperature of the optical fiber to be delivered into the annealing furnace is limited to a more suitable range in this manner. Thus, the effect of promoting the relaxation of the structure of glass forming the optical fiber in the annealing furnace can be easily increased, and transmission losses in the optical fiber can be easily reduced.

Preferably, the temperature of the optical fiber to be delivered out of the annealing furnace is a temperature of 1,300° C. or more. The temperature of the optical fiber to be delivered out of the annealing furnace is limited to a more suitable range in this manner. Thus, the effect of promoting the relaxation of the structure of glass forming the optical fiber in the annealing furnace can be easily increased, and transmission losses in the optical fiber can be easily reduced.

Preferably, a time period for cooling the optical fiber in the annealing furnace is one second or less. The residence time of the optical fiber in the annealing furnace is one second or less. Thus, costs on capital investment can be reduced, such as a decrease in the length of the annealing furnace. The residence time of the optical fiber in the annealing furnace is set to a short period as one second or less, allowing the drawing rate to be increased. Accordingly, the relaxation of the structure of glass forming the optical fiber in the annealing furnace can be promoted with no degradation of productivity.

Preferably, a time period for cooling the optical fiber in the annealing furnace is 0.5 second or less. The residence time of the optical fiber in the annealing furnace is more decreased, allowing the length of the annealing furnace to be more decreased. Thus, costs on capital investment can be further reduced. The residence time of the optical fiber in the annealing furnace is more decreased, easily reducing the degradation of productivity.

Preferably, a time period for cooling the optical fiber in the annealing furnace is 0.05 second or more. The residence time of the optical fiber in the annealing furnace is set to 0.05 second or more. Thus, the relaxation of the structure of glass forming the optical fiber in the annealing furnace is easily promoted.

Preferably, the method includes a precooling process of cooling the optical fiber so that a temperature of the optical fiber is suitable for delivering the optical fiber into the drawing furnace after the drawing process and before the slow cooling process. The temperature of the optical fiber to be delivered into the annealing furnace is limited to a predetermined range as described above. Here, the precooling process as described above is further included, easily adjusting the incoming temperature of the optical fiber to the annealing furnace to a suitable range.

As described above, according to the present invention, there is provided a manufacturing method for an optical fiber that easily reduces transmission losses in the optical fiber.

### BRIEF DESCRIPTION OF DRAWINGS

FIG. 1 is a flowchart of the processes of a manufacturing method for an optical fiber according to the present invention.

FIG. 2 is a schematic diagram of the configuration of devices for use in a manufacturing method for an optical fiber according to the present invention.

FIG. 3 is a graph of the relationship between the temperature of an optical fiber and the virtual temperature of glass forming the optical fiber and cooling time.

FIG. 4 is a graph of the relationship between a change in the outer diameter of a neck-down portion, a change in the temperature of the optical fiber, and a change in the virtual temperature of glass forming the optical fiber.

### DESCRIPTION OF EMBODIMENTS

In the following, a preferred embodiment of a manufacturing method for an optical fiber according to the present invention will be described in detail with reference to the drawings.

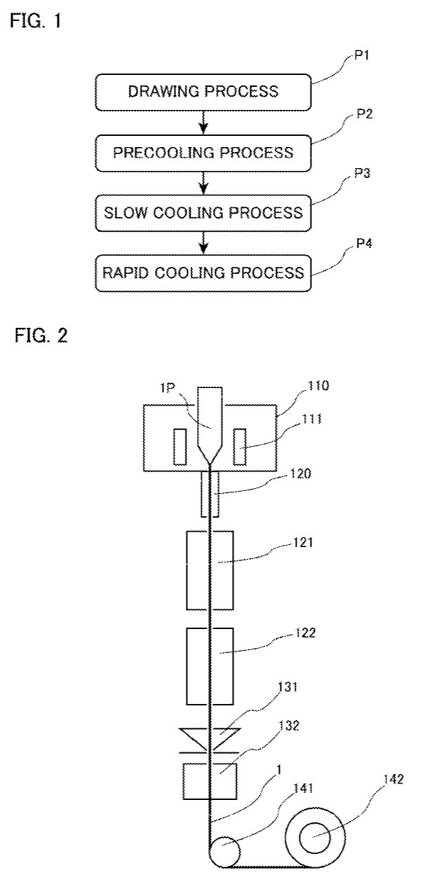

FIG. 1 is a flowchart of the processes of a manufacturing method for an optical fiber according to the present invention. As illustrated in FIG. 1, the manufacturing method for an optical fiber according to the embodiment includes a drawing process P1, a precooling process P2, a slow cooling process P3, and a rapid cooling process P4. In the following, these processes will be described. Note that, FIG. 2 is a schematic diagram of the configuration of devices for use in the manufacturing method for an optical fiber according to the embodiment.

### Drawing Process P1

The drawing process P1 is a process in which one end of an optical fiber preform 1P is drawn in a drawing furnace 110. First, the optical fiber preform 1P is prepared. The optical fiber preform 1P is formed of glass having a desired refractive index profile similar to the refractive index profile of glass forming an optical fiber 1, which is a final product. The optical fiber 1 includes one or a plurality of cores and a cladding surrounding the outer circumferential surface of the core with no gap. The refractive index of the core is higher than the refractive index of the cladding. For example, in the case in which the core is formed of silica glass doped with a dopant, such as germanium, which increases the refractive index, the cladding is formed of pure silica glass. For example, in the case in which the core is formed of pure silica glass, the cladding is formed of silica glass doped with a dopant, such as fluorine, which decreases the refractive index. Subsequently, the optical fiber preform 1P is suspended so that the longitudinal direction is perpendicular. The optical fiber preform 1P is disposed in the drawing furnace 110, a heating unit 111 is caused to generate heat, and then the lower end portion of the optical fiber preform 1P is heated. At this time, the lower end portion of the optical fiber preform 1P is heated at a temperature of 2,000° C., for example, to be molten. From the heated lower end portion of the optical fiber preform 1P, molten glass is drawn out of the drawing furnace 110 at a predetermined drawing rate.

### Precooling Process P2

The precooling process P2 is a process in which the optical fiber drawn out of the drawing furnace 110 in the drawing process P1 is cooled to a predetermined temperature suitable for delivering the optical fiber into an annealing furnace 121, described later. A predetermined temperature of the optical fiber suitable for delivering the optical fiber into the annealing furnace 121 will be described in detail.

In the manufacturing method for an optical fiber according to the embodiment, the precooling process P2 is performed by passing the optical fiber drawn in the drawing process P1 through the hollow portion of a tubular body 120 provided directly below the drawing furnace 110. The tubular body 120 is provided directly below the drawing furnace 110, causing the atmosphere in the inside of the hollow portion of the tubular body 120 to be almost the same as the atmosphere in the inside of the drawing furnace 110. Thus, a rapid change in the ambient atmosphere and the ambient temperature around the optical fiber immediately after drawn is reduced.

Various conditions affect the temperature of the optical fiber to be delivered to the annealing furnace 121. The drawing rate is one of the conditions that greatly affect the temperature of the optical fiber. That is, when the drawing rate is changed in order to adjust the residence time of the optical fiber in the annealing furnace 121, the temperature of the optical fiber is changed. The precooling process P2 is provided, which adjusts the cooling rate of the optical fiber for easy adjustment of the incoming temperature of the optical fiber to be delivered into the annealing furnace 121 to a suitable range. As described later, the temperature of the optical fiber to be drawn out of the drawing furnace 110 can be estimated front the shape of the neck-down portion. Based on the temperature of the optical fiber estimated in this manner and the temperature of the optical fiber suitable for delivering the optical fiber into the annealing furnace 121, the distance from the annealing furnace 121 to the drawing furnace 110 and the length of the tubular body 120 can be appropriately selected. The tubular body 120 is formed of a metal tube, for example. The cooling rate of the optical fiber may be adjusted by air-cooling the metal tube or by providing a heat insulator around the metal tube.

### Slow Cooling Process P3

The slow cooling process P3 is a process in which the optical fiber, which is drawn out of the drawing furnace 110 in the drawing process P1 and whose temperature is adjusted to a predetermined temperature in the precooling process P2, is slowly cooled in the annealing furnace 121. The temperature in the inside of the annealing furnace 121 is a predetermined temperature different from the temperature of the optical fiber to be delivered into the annealing furnace 121. The cooling rate of the optical fiber is decreased by the ambient temperature around the optical fiber delivered into the annealing furnace 121. The cooling rate of the optical fiber is decreased in the annealing furnace 121. Thus, the structure of glass forming the optical fiber is relaxed, and the optical fiber 1 with decreased scattering losses is obtained, as described below. Note that, in the slow cooling process P3, the temperature of the optical fiber is preferably continuously decreased. The temperature of the annealing furnace 121 is set so that the temperature of the optical fiber is continuously decreased as described above. Thus, the optical fiber is slowly cooled to promote the relaxation of the structure of glass forming the optical fiber without wasting energy, allowing a reduction in transmission losses in the optical fiber.

In a manufacturing method for an optical fiber having a previously existing slow cooling process, the temperature of the optical fiber is not sufficiently optimized when the optical fiber is delivered into the annealing furnace. Specifically, the optical fiber is sometimes delivered into the annealing furnace with the temperature of the optical fiber being too high or too low. When the temperature of the optical fiber to be delivered into the annealing furnace is too high, the rate to relax the structure of glass forming the optical fiber is too fast, hardly expecting the effect of slowly cooling the optical fiber. On the other hand, when the temperature of the optical fiber to be delivered into the annealing furnace is too low, the rate to relax the structure of glass forming the optical fiber is decreased, sometimes causing a necessity to again heat the optical fiber in the annealing furnace, for example. As described above, in the previously existing slow cooling process, it is difficult to say that the relaxation of the structure of glass forming the optical fiber is efficiently performed. Thus, the annealing furnace is elongated more than necessary for excessive capital investment or the drawing rate is decreased more than necessary, which might degrade productivity.

As described below, according to the manufacturing method for an optical fiber of the embodiment, the temperature of the optical fiber to be delivered into the annealing furnace 121 and the temperature of the optical fiber to be delivered out of the annealing furnace 121 are controlled in suitable ranges. Thus, the relaxation of the structure of glass forming the optical fiber is promoted in the annealing furnace 121. As a result, the optical fiber 1 of excellent productivity with decreased transmission losses can be obtained with no requirement of excessive capital investment. According to the manufacturing method for an optical fiber of the embodiment, complex calculation is not necessary unlike the technique disclosed in Patent Literature 1 described above.

In silica glass sorted into a so-called strong glass, the time constant τ(T) of the structure relaxation, whose cause is thought to be the viscosity flow of glass, follows the Arrhenius equation. Thus, the time constant τ(T) is expressed as Equation (1) as a function of the temperature T of glass using the constant A determined by the composition of glass and the activation energy E_{act}. Note that, k_{b} is the Boltzmann constant.

1/τ(T)=A·exp (−E_{act}/k_{b}T) (1)

(Here, T is the absolute temperature glass.)

Equation (1) above shows that the structure of glass is relaxed faster as the temperature of glass is higher and the equilibrium state at the temperature is reached faster. That is, the virtual temperature of glass comes close to the temperature of glass faster as the temperature of glass is higher.

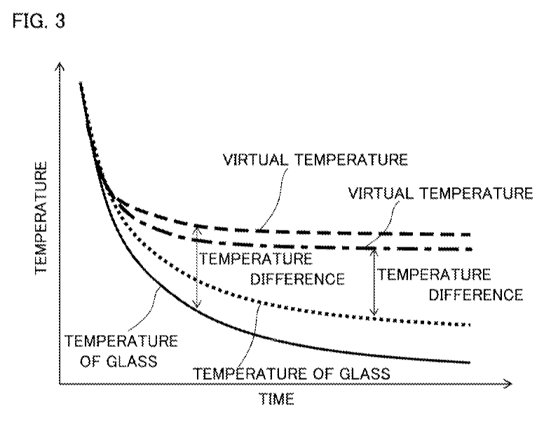

FIG. 3 schematically illustrates a drop in the virtual temperature of glass forming the optical fiber caused by slowly cooling the optical fiber. In FIG. 3, the horizontal axis expresses time, and the vertical axis expresses temperature. In FIG. 3, a solid line expresses the transition of the temperature of the optical fiber under certain slow cool conditions, and a broken line expresses the transition of the virtual temperature of glass forming the optical fiber at that time. A dotted line expresses the transition of the temperature of the optical fiber in the case in which the cooling rate is decreased more slowly than the slow cool conditions expressed by the solid line. An alternate long and short dash line expresses the transition of the virtual temperature of glass forming the optical fiber at that time.

As expressed by the solid line in FIG. 3, when the temperature of the optical fiber is decreased over time, as expressed by the broken line, the virtual temperature is similarly decreased as the temperature of the optical fiber is decreased. As described above, in the state in which the temperature of the optical fiber is sufficiently high, the rate of the relaxation of the structure of glass forming the optical fiber is fast. However, as the temperature of the optical fiber is decreased, the rate of the relaxation of the structure of glass is decreased, and the virtual temperature fails to follow a drop in the temperature of the optical fiber after a while. Here, when the cooling rate of the optical fiber is slowed, the optical fiber is held in a relatively high temperature state for a long time, compared with the case in which the cooling rate is fast. Thus, as expressed by the dotted line and the alternate long and short dash line in FIG. 3, the difference between the temperature of the optical fiber and the virtual temperature is decreased, and the virtual temperature is further decreased. That is, the relaxation of the structure of glass is promoted. As described above, how it is possible to promote the relaxation of the structure of glass forming the optical fiber depends on the temperature history of the optical fiber. Therefore, the following is a concept showing which slow cool conditions are suitable for reducing the transmission losses in optical fibers.

The temperature of the optical fiber immediately after drawn out of the drawing furnace 110 is about 1,800 to 2,000° C., which are very high temperatures. At this time, when the time constant τ(T) of the relaxation of the structure of glass forming the optical fiber is calculated using the constant A and the activation energy E_{act} shown in Non-Patent Literature (K. Saito, et al., Journal of the American Ceramic Society, Vol. 89, pp. 65-63 (2006), for example, the time constant τ(T) is about 0.00003 second in the case in which the temperature of the optical fiber is 2,000° C., and the time constant τ(T) is 0.0003 second in the case in which the temperature of the optical fiber is 1,800° C. The time constant τ(T) is very short. In such high temperature states, it is thought that the virtual temperature of glass forming the optical fiber is nearly matched with the temperature of the optical fiber. Thus, the structure of glass is immediately relaxed even though the optical fiber is slowly cooled in such a high temperature range, resulting in poor expectations of the effect of slowly cooling the optical fiber. Consequently, the direct arrangement of the annealing furnace 121 below the drawing furnace 110 for slowly cooling the optical fiber is excessive capital investment. That is, it is fine to provide a gap between the drawing furnace 110 and the annealing furnace 121, and it is preferable to perform, the precooling process P2 so that the temperature of the optical fiber to be delivered into the annealing furnace 121 is optimized.

The outer diameter of the optical fiber drawn from the optical fiber preform is continuously decreased from the outer diameter of the optical fiber preform to a predetermined diameter (the outer diameter of a typical optical fiber is 125 μm). The portion, in which the outer diameter of the optical fiber drawn from the optical fiber preform is changed, is referred to as the neck-down portion. The temperature T of the optical fiber is found from the force balance and material balance of the neck-down portion. Specifically, the change rate of a cross sectional area S of the neck-down portion of the optical fiber preform in the stationary state at a rate v for drawing the optical fiber has the relationship with the tension F applied to the optical fiber being drawn as Equation (2) below, where the longitudinal direction for drawing is x.

v·ds/dx=V·S₀/s₀·dS/dx=−F/β(T) (2)

Here, S₀ is the cross sectional area of the optical fiber preform, s₀ is the nominal cross sectional area of the optical fiber, and V is the deliver rate of the optical fiber preform. β(T) is the normal viscosity coefficient at the temperature T of glass, which is three times the viscosity η. That is, Equation (3) below is held.

β(T)=3η(T) (3)

The viscosity η of silica glass is found by Equation (4) below.

log₁₀{η(T)}=B+C/T (4)

When the viscosity η is expressed by the unit [Pa·s], B=−6.37 and C=2.32×10⁴ [K⁻¹]. From Equation (4) above, the temperature T of glass can be found from the viscosity η found by Equation (3) above.

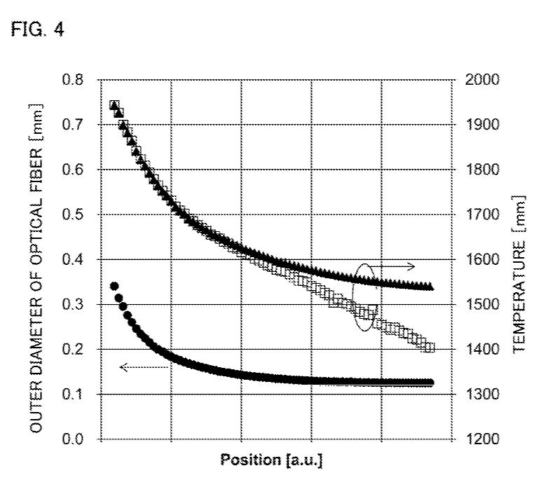

FIG. 4 is the relationship between a change in the outer diameter of the optical fiber of the neck-down portion (), a change in the temperature of the optical, fiber found from the change in the outer diameter of the neck-down portion (□) , and a change in the virtual temperature of glass forming the optical fiber found from the change in the temperature of the optical fiber (▴) under certain drawing conditions. It is revealed that as the temperature of the optical fiber is decreased to increase the viscosity of glass forming the optical fiber, a change in the outer diameter of the optical fiber is slowed. After the temperature of the optical fiber is below a temperature of about 1,650° C., a drop in the virtual temperature of glass forming the optical fiber fails to follow a drop in the temperature of the optical fiber, increasing the temperature difference between them. That is., before the temperature of the optical fiber reaches a temperature of about 1,650° C., the virtual temperature of glass forming the optical fiber is nearly matched with the temperature of the optical fiber without slowly cooling the optical fiber. Thus, the effect of slowly cooling the optical fiber is subtle before the temperature of the optical fiber reaches a temperature of 1,650° C. or less. Consequently, the incoming temperature of the optical fiber to be delivered into the annealing furnace 121 is 1,650° C. or less.

The relaxation of the structure of glass forming the optical fiber can be more promoted as the residence time of the optical fiber in the annealing furnace 121 is more increased, allowing the optical fiber with decreased transmission losses to be manufactured. However, under economical conditions taking into account of productivity and capital investment, the residence time of the optical fiber in the annealing furnace 121 is preferably one second or less. When the time constant τ(T) of the relaxation of the structure of glass is calculated using a predetermined constant for Equation (1) above, τ(T) is 0.1 second or less when the temperature of glass is about 1,420° C., τ(T) is one second when the temperature of glass is about 1,310° C., and τ(T) is ten seconds when the temperature of glass is about 1,210° C. Thus, in order to sufficiently obtain the effect of slowly cooling the optical fiber even though the residence time of the optical fiber in the annealing furnace 121 is about one second, the incoming temperature of the optical fiber to foe delivered into the annealing furnace 121 is 1,300° C. or more, and preferably 1,400° C. or more.

As described above, as the temperature of the optical fiber is decreased, a time period required for the relaxation of the structure of glass forming the optical fiber is increased. Specifically, when the temperature of the optical fiber is below 1,150° C., it is difficult to relax the structure of glass in slow cooling for a short time. Thus, the temperature of the optical fiber to be delivered out of the annealing furnace is 1,150° C. or more and 1,400° C. or less, and preferably 1,300° C. or more.

The residence time of the optical fiber in the annealing furnace 121 is preferably 0.01 second or more, and more preferably 0.05 second or more. The structure of glass forming the optical fiber is more easily relaxed as the residence time of the optical fiber in the annealing furnace 121 is more increased. The residence time of the optical fiber in the annealing furnace 121 is preferably one second or less, and more preferably 0.5 second or less. The length of the annealing furnace 121 can be more decreased, as the residence time of the optical fiber in the annealing furnace 121 is more decreased. Thus, excessive capital investment can be reduced. The drawing rate can be more increased as the residence time of the optical fiber in the annealing furnace 121 is more decreased. Consequently, the productivity of the optical fiber can be improved.

Note that, the length of the annealing furnace 121 can be set as below. The temperature history, in which the virtual temperature of glass forming the optical fiber is the lowest, depends only on slow cooling time t. Thus, time t necessary to slowly cool the optical fiber is found from the virtual temperature that can achieve transmission losses, which the optical fiber to be manufactured has to reach, and the drawing rate v is determined taking into account of productivity. Consequently, a necessary length L of the annealing furnace 121 is found from Equation (5) below.

t=L/v (5)

### Rapid Cooling Process P4

After the slow cooling process P3, in order to enhance the resistance against external flaws, for example, the optical fiber is covered with a buffer layer. Typically, this buffer layer is formed of an ultraviolet curable resin. In order to form such at buffer layer, it is necessary to sufficiently cool the optical fiber at a low temperature for preventing the buffer layer from being burn, for example. The temperature of the optical fiber affects the viscosity of a resin to be applied, and as a result, this affects the thickness of the buffer layer. A suitable temperature of the optical fiber in forming the buffer layer is appropriately determined suitable for the properties of a resin forming the buffer layer.

In the manufacturing method for an optical fiber according to the embodiment, the annealing furnace 121 is provided to decrease the section for sufficiently cooling the optical fiber. More specifically, the manufacturing method for an optical fiber according to the embodiment also includes the precooling process P2, further decreasing the section sufficiently cooling the optical fiber. Thus, the manufacturing method for an optical fiber according to the embodiment includes the rapid cooling process P4 in which the optical fiber delivered out of the annealing furnace 121 is rapidly cooled using a cooling device 122. In the rapid cooling process P4, the optical fiber is rapidly cooled faster than in the slow cooling process P3. The rapid cooling process P4 performed in this manner is provided. Thus, the temperature of the optical fiber can be sufficiently decreased in a short section, easily forming the buffer layer. The temperature of the optical fiber when it is delivered out of the cooling device 122 ranges from temperatures of 40 to 50° C., for example.

As described, above, the optical fiber, which has been passed through the cooling device 122 and cooled to a predetermined temperature, is passed through a coater 131 containing an ultraviolet curable resin to be the buffer layer that covers the optical fiber, and the optical fiber is covered with this ultraviolet curable resin. The optical fiber is further passed through an ultraviolet irradiator 132, ultraviolet rays are applied to the optical fiber, the buffer layer is formed, and then the optical fiber 1 is formed. Note that, the buffer layer is typically formed of two layers. In the case of forming a two-layer buffer layer, after the optical fiber is covered with ultraviolet curable resins forming the respective layers, the ultraviolet curable resins are cured at one time, and then the two-layer buffer layer can be formed. Alternatively, after forming a first buffer layer, a second buffer layer may be formed. The direction of the optical fiber 1 is changed by a turn pulley 141, and then the optical fiber 1 is wound on a reel 142.

As described above, the present invention is described as the preferred embodiment is taken as an example. The present invention is not limited to this embodiment. That is, the manufacturing method for an optical fiber according to the present invention only has to include the slow cooling process described above. The preceding process and the rapid cooling process are not essential processes. The manufacturing method for an optical fiber according to the present invention is applicable to the manufacture of any types of optical fibers.

### EXAMPLES

In the following, the content of the present invention will be described more in detail taking examples and a comparative example. However, the present invention is not limited to them.

### Examples 1 to 9

Using a preform for a standard single mode optical, fiber in which its core was doped with germanium, its refractive index profile was a step index refractive index profile, and the relative refractive index difference of the core to the cladding was 0.33%, optical fibers were manufactured under the conditions below.

An air-cooled metal tube in length ranging from 30 cm to 1 m was mounted directly below a drawing furnace. The atmosphere in the inside of the hollow portion of the air-cooled metal tube was almost the same as the atmosphere (inert mixed gas) in the inside of the drawing furnace. Thus, the ambient atmosphere and the ambient temperature around the optical fiber immediately after drawn were prevented from being suddenly changed from the molten position of the optical fiber preform to the neck-down portion. With this configuration, the optical fiber drawn out of the drawing furnace was precooled to a temperature suitable for delivering the optical fiber into the annealing furnace while passing the optical fiber through the inside of the hollow portion of the air-cooled metal tube. The distance from the outlet port of the air-cooled metal tube to the inlet port of the annealing furnace was set from 200 to 350 mm, and this range was opened in the atmosphere.

The incoming temperature and the outgoing temperature of the optical fiber to be delivered into and out of the annealing furnace were measured at a position 100 to 200 mm apart from the inlet port or the outlet port of the annealing furnace using a non-contact fiber thermometer made by Rosendahl Nextrom GmbH, and the values were shown by three significant digits on Table 1. The residence time in the annealing furnace corresponds to a time period for which the optical fiber is cooled in the annealing furnace. The residence time was calculated from the length of the annealing furnace and the drawing rate, and the values were shown by one significant digit on Table 1.

The optical fiber delivered out of the annealing furnace was rapidly cooled to a temperature, at which a resin buffer layer can be formed, by passing the optical fiber through the inside of the hollow portion of a water-cooled metal tube (a cooling device) communicating with a gas containing helium (He). The temperature of the optical fiber was adjusted by adjusting the concentration of He or by adjusting the number of the water-cooled metal tubes so that the resin buffer layer had a desired thickness.

Transmission losses of the optical fibers manufactured as described above were measured at a wavelength of 1,550 nm by optical time-domain reflectometry (OTDR). The result, is shown in Table 1. Note that, the cable length was 20 km or more.

### Comparative Example 1

An optical fiber was manufactured under the conditions similar to the conditions of the first embodiment except that no annealing furnace was used, and transmission losses were measured by a similar method. The result was shown in Table 1.

As shown in Table 1, in the case of Comparative Example 1 in which the optical fiber was not slowly cooled, the transmission loss was 0.18.5 dB/km.

In contrast, in the optical fibers of Examples 1 to 9, the transmission loss was 0.183 dB or less, allowing the transmission loss to be made smaller than in the optical fiber of the comparative example. Note that, in the optical fibers of Examples 1 to 9 and the optical fiber of Comparative Example 1, their optical properties except transmission losses were matched in a range of possible variations in typical manufacture of optical fibers. It was confirmed that the optical properties were equivalent to the optical properties of the standard single mode optical fiber.

More specifically, in Examples 1 to 4, the optical fibers were slowly cooled under suitable conditions, and thus excellent optical fibers were manufactured with a transmission loss of 0.180 dB/km or less.

In contrast, even under the conditions as in the first embodiment in which the length of the annealing furnace was short, the drawing rate was fast, and the residence time in the annealing furnace was as short as 0.05 second, achieving a transmission loss of 0.180 dB/km by slowly cooling the optical fiber with a suitable temperature history, and allowing an optical fiber with low transmission losses to be manufactured even under highly economical conditions.

TABLE 1

| | Annealing | Annealing | | |
|---|---|---|---|---|
| | furnace | furnace | Annealing | Transmission |
| | incoming | outgoing | furnace | loss |
| | temperature/ | temperature/ | residence | (1,550 nm)/ |
| | ° C. | ° C. | time/second | dB/km |
| Example 1 | 1400 | 1390 | 0.05 | 0.180 |
| Example 2 | 1400 | 1360 | 0.1 | 0.179 |
| Example 3 | 1450 | 1340 | 0.2 | 0.178 |
| Example 4 | 1500 | 1320 | 0.3 | 0.177 |
| Example 5 | 1350 | 1300 | 0.3 | 0.183 |
| Example 6 | 1300 | 1200 | 0.3 | 0.183 |
| Example 7 | 1400 | 1150 | 0.3 | 0.182 |
| Example 8 | 1500 | 1180 | 0.3 | 0.182 |
| Example 9 | 1330 | 1280 | 0.1 | 0.183 |
| Comparative | | | | 0.185 |
| Example 1 | | | | |

### REFERENCE SIGNS LIST

1 . . . optical fiber
1P . . . optical fiber preform
110 . . . drawing furnace
111 . . . heating unit
120 . . . tubular body
121 . . . annealing furnace
122 . . . cooling device
131 . . . coater
132 . . . ultraviolet irradiator
141 . . . turn pulley
142 . . . reel
P1 . . . drawing process
P2 . . . precooling process
P3 . . . slow cooling process
P4 . . . rapid cooling process

1. A manufacturing method for an optical fiber comprising:
a drawing process of drawing an optical fiber from an optical fiber preform in a drawing furnace; and
a slow cooling process of slowly cooling the optical fiber drawn in the drawing process in an annealing furnace, wherein
a temperature of the optical fiber to be delivered into the annealing furnace is 1,300° C. or more and 1,650° C. or less, and a temperature of the optical fiber to be delivered out of the annealing furnace is 1,150° C. or more and 1,400° C. or less.

2. The manufacturing method for an optical fiber according to claim 1, wherein
in the slow cooling process, the temperature of the optical fiber is continuously decreased.

3. The manufacturing method for an optical fiber according to claim 1, comprising
a rapid cooling process of rapidly cooling the optical fiber faster than in the slow cooling process after the slow cooling process.

4. The manufacturing method for an optical fiber according to claim 1, wherein
the temperature of the optical fiber to be delivered into the annealing furnace is 1,400° C. or more.

5. The manufacturing method for an optical fiber according to claim 1, wherein
the temperature of the optical fiber to be delivered out of the annealing furnace is 1300° C. or more.

6. The manufacturing method for an optical fiber according to claim 1, wherein
a time period for cooling the optical fiber in the annealing furnace is one second or less.

7. The manufacturing method for an optical fiber according to claim 6, wherein
a time period for cooling the optical fiber in the annealing furnace is 0.5 second or less.

8. The manufacturing method for an optical fiber according to claim 1, wherein
a time period for cooling the optical fiber in the annealing furnace is 0.05 second or more.

9. The manufacturing method for an optical fiber according to claim 1, comprising
a precooling process of cooling the optical fiber so that a temperature of the optical fiber is suitable for delivering the optical fiber into the annealing furnace after the drawing process and before the slow cooling process.
